(19) United States
(12) Patent Application Publication
(10) Pub. No.: US 2015/0032506 A1
(43) Pub. Date: Jan. 29, 2015

(54) DEMAND FORECAST SEGMENTATION APPARATUS AND METHOD, APPARATUS AND METHOD FOR ADJUSTING DEMAND FORECAST AND RECORDING MEDIUM RECORDING PROGRAM THEREOF

(71) Applicant: SAMSUNG SDS CO., LTD., Seoul (KR)

(72) Inventors: Dong Ho KIM, Anyang-si (KR); Kang Hyoung CHO, Seoul (KR); Won Seok CHOI, Yongin-si (KR)

(73) Assignee: SAMSUNG SDS CO., LTD., Seoul (KR)

(21) Appl. No.: 14/444,458

(22) Filed: Jul. 28, 2014

(30) Foreign Application Priority Data
Jul. 26, 2013 (KR) 10-2013-0088939

(51) Int. Cl. G06Q 30/02

(52) U.S. Cl. CPC G06Q 30/0202
USPC 705/7.31

(57) ABSTRACT

An apparatus for adjusting a demand forecast received for each sales area by putting top priority on a committed order and putting next priority on a new order using information on a predetermined planned supply. The apparatus includes a demand forecast receiving unit receiving a demand forecast, a supply commit acquisition unit acquiring information on a supply commit, and a demand forecast adjusting unit comparing the received demand forecast with the information on the supply commit and adjusting the demand forecast received from the demand forecast receiving unit.

### CROSS-REFERENCE TO RELATED APPLICATION

This application claims priority from Korean Patent Application No. 10-2013-0088939 filed on Jul. 26, 2013 in the Korean Intellectual Property Office, the disclosure of which is incorporated herein by reference in its entirety.

### BACKGROUND OF THE INVENTION

1. Field of the Invention

The present invention relates to a demand forecast segmentation apparatus and method, an apparatus and method for adjusting demand forecast, and a recording medium recording a program thereof. More particularly, the present invention relates to a demand forecast segmentation apparatus and method, an apparatus and method for adjusting a demand forecast by each sales area by putting top priority on a committed order and putting next priority on a new order, and a recording medium recording a program thereof.

2. Description of the Related Art

An enterprise may usually have a hierarchical sales organization and various sales levels of the hierarchical sales organization may have business areas corresponding thereto.

Meanwhile, in order to achieve demand forecast and production management of the enterprise, managers in charge of the respective sales levels may calculate demand forecasts for the respective sales levels and may enter the calculated demand forecasts into an in-house computerized system.

In the conventional apparatus and method, the demand forecasts entered by the respective managers are simply classified into orders and net demand forecasts, and supply planning is established at the enterprise level through the demand forecast.

However, in the conventional supply planning based on the demand forecast, when a particular sales area, a particular sales corporation or sales organization increases demand forecasts, the committed order may be transferred to a sales area with greatly increasing demands, which will now be described with reference to FIG. 1 by way of example.

FIG. 1 illustrates an exemplary embodiment in which supply quantities are changed due to an increase in the demand forecast of a particular sales area.

Referring to FIG. 1, last week, demand forecasts from sales areas of France and Germany were 50, respectively. That is to say, a total demand forecast of the last week was 100. Committed supplies established were 50, respectively. That is to say, a total supply commit of the last week was 100.

This week, while a demand forecast from France is still 50, a demand forecast from Germany is increased to 100. That is to say, a total demand forecast from Europe becomes 150, while a total supply commit is still 100. The supply planning is established based on the estimated demand ratio of each sales area. Thus, while the demand forecast of France is the same with that in the last week, i.e., 50, the sales area of France is supplied with a smaller supply of products, i.e., 33, than the demand forecast in the last week, i.e. 50, due to the increase in the demand forecast of the other sales area of Germany.

Changing the supply commit of a sales area due to a variation in the demand of another sales area is against supply fairness, and demand estimation arises for securing a quantity of products so that inaccurate information on estimated demands may be entered.

Accordingly, it is necessary to propose measures for adjusting the demand forecast to minimize the variation in the planned supplies committed to different sales organizations having differently varying demand forecasts while maintaining supply fairness.

### SUMMARY OF THE INVENTION

The present invention provides an apparatus for adjusting a demand forecast receive for each sales area by putting top priority on a committed order and putting next priority on a new order.

The present invention also provides an apparatus for adjusting a demand forecast, for each sales area to secure a quantity of products in advance planned or committed to be supplied to a particular sales area even when there is an increase in the demand forecast from another sales area.

The present invention also provides a demand forecast segmentation apparatus, which further segments a demand forecast into information on orders, supply commit and so on, using information on demand forecast for each sales area, current order, and predetermined supply planning, rather than using the conventional method in which a demand forecast is simply segmented into an order and a forecast, and a demand forecast adjusting apparatus, which adjusts the demand forecast using the segmented demand forecast information, thereby maintaining supply fairness.

The above and other objects of the present invention will be described in or be apparent from the following description of the preferred embodiments.

According to an aspect of the present invention, there is provided an apparatus for adjusting a demand forecast, the apparatus including a demand forecast receiving unit receiving a demand forecast; a supply commit acquisition unit acquiring information on a supply commit; and a demand forecast adjusting unit comparing the received demand forecast with the information on the supply commit and adjusting the demand forecast received from the demand forecast receiving unit.

According to another aspect of the present invention, there is provided a method for adjusting a demand forecast, the method including receiving a demand forecast, acquiring information on a supply commit, and comparing the received demand forecast with the information on the supply commit and adjusting the demand forecast received in the receiving of the demand forecast.

According to still another aspect of the present invention, there is provided a demand forecast segmentation method including receiving information on a demand forecast, acquiring information on a supply commit, and segmenting the demand forecast into a demand forecast corresponding to the information on the supply commit and a demand forecast not corresponding to the information on the supply commit, using the information on the received demand forecast and the supply commit.

According to yet another aspect of the present invention, there is provided a computer readable recording medium including receiving information on a demand forecast, acquiring information on a supply commit, and comparing the demand forecast with the information on the supply commit and adjusting the received demand forecast.

As described above, according to the present invention, information on the demand forecast can be further segmented using information on a supply commit and so on.

In addition, according to the present invention, the demand forecast is adjusted for each sales area, thereby maximally maintaining the supply commit for each sales area.

That is to say, according to the present invention, the demand forecast can be adjusted so as not to unreasonably change a supply commit of a particular sales area due to an increase in the demand forecast of another sales area.

Further, according to the present invention, even when there is a surplus supply quantity or a short supply quantity for each sales area, the demand forecast for each sales area can be adjusted in consideration of a supply commit for each sales area, thereby achieving reasonable supply planning, compared to the conventional demand forecasting.

### BRIEF DESCRIPTION OF THE DRAWINGS

The above and other features and advantages of the present invention will become more apparent by describing in detail preferred embodiments thereof with reference to the attached drawings in which:

FIG. 1 illustrates an exemplary embodiment in which supply quantities are changed due to an increase in the demand forecast of a particular sales area;

FIG. 2 illustrates a demand forecasting and supply planning process;

FIG. 3 illustrates an example of a layered structure of a demand forecasting sales organization having a global marketing network;

FIG. 4 is a block diagram of a demand forecast adjusting apparatus according to an embodiment of the present invention;

FIG. 5 is a block diagram of a demand forecast segmentation apparatus according to an embodiment of the present invention;

FIGS. 6A, 6B, and 6C illustrate a segmentation example of demand forecast information segmented by a demand forecast segmentation unit of the demand forecast segmentation apparatus shown in FIG. 5;

FIG. 7 is a block diagram of a modified example of the demand forecast adjusting apparatus according to an embodiment of the present invention, further comprising a demand forecast segmentation unit;

FIG. 8 illustrates demand forecasting under the same condition as in FIG. 1 when the demand forecast adjusting apparatus according to an embodiment of the present invention is employed;

FIG. 9 illustrates layered sales areas of various levels;

FIG. 10 is a schematic diagram of a demand forecast adjusting apparatus according to an embodiment of the present invention; and

FIG. 11 is a flowchart illustrating a demand forecast adjusting method according to an embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Thus, in some embodiments, well-known structures and devices are not shown in order not to obscure the description of the invention with unnecessary detail Like numbers refer to like elements throughout.

It will be understood that when an element or layer is referred to as being “coupled to” or “connected to” another element or layer, it can be directly on or connected to the other element or layer or intervening elements or layers may be present. In contrast, when an element is referred to as being “directly coupled to” or “directly connected to” another element or layer, there are no intervening elements or layers present. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

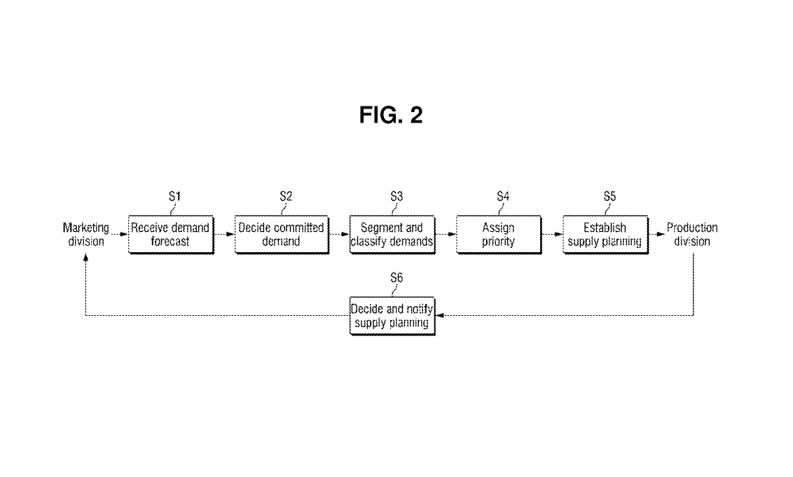

A demand forecasting and supply planning process will now be described with reference to FIG. 2. First, sales volumes for a predetermined future period (planning period) agreed between a marketing division and a production division are forecasted and values representing the forecasted sales volumes are entered to an associated computer system as inputs on a daily, weekly or monthly basis (S1). The input values are used in deciding committed demands after due consultation of participants in demand forecasting (S2). The decided committed demands are segmented and classified according to components of the decided demand based on order information for orders placed during the planning period and existing supply planning information (S3). Each of the decided committed demands is assigned with priority according to the pre-calculated profitability of products and significance levels of clients (S4). For the decided demand with priority assigned thereto, availability of materials required for production of the products and equipment required for assembling and fabrication of the products are checked and supply planning is established (S5). Feasibility of the established supply planning is finally checked and adjusted to then notify the production division of the established supply planning (S6).

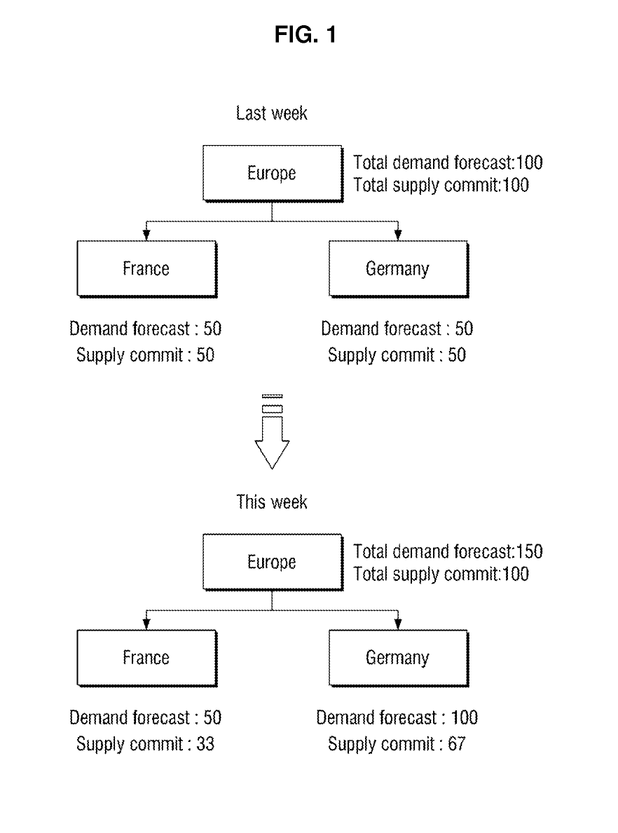

According to an embodiment of the present invention, the demand forecasting and supply planning process can be used in the step (S3) of segmenting and classifying the decided demands using the information on the orders placed during the planning period shown in FIG. 1 and the information on the existing supply planning. However, the present invention can also be applied to other fields for adopting advantages and effects of the present invention as well as the step (S3) of segmenting and classifying the decided demands.

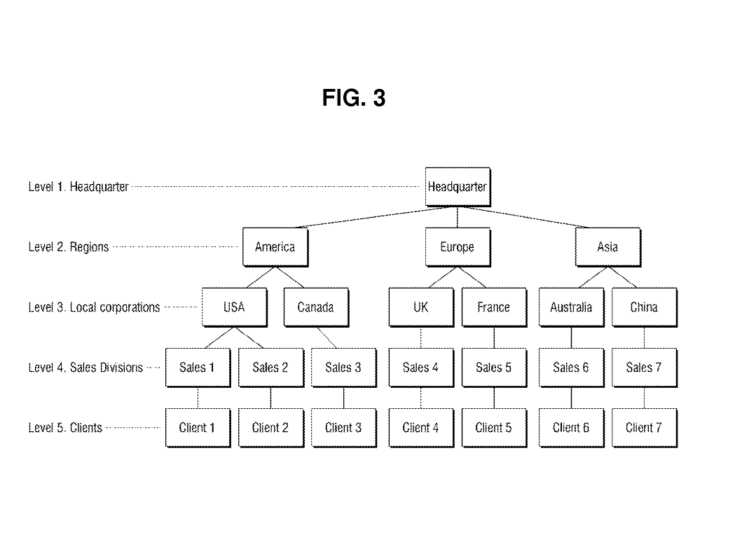

FIG. 3 illustrates an example of a layered structure of a demand forecasting sales organization having a global marketing network.

Enterprises may have different structures and levels in their demand forecasting or sales organizations. In FIG. 3, an example of a layered structure of a demand forecasting sales organization is illustrated, the demand forecasting sales organization comprised of levels of a headquarter, regions, local corporations, sales organizations, and clients.

Hereinafter, some terms will be defined.

Measure parameters indicate who has entered a demand forecast. For example, L1_Forecast measure indicates a demand forecast entered by a manager in charge of a level 1 (L1).

Table 1 demonstrates parameter names referring to input values in a case where demand forecasts are entered by a demand forecasting organization (sales organization) shown in FIG. 3.

TABLE 1

| Information | | |
|---|---|---|
| classified | Measure parameter | Description |
| Demand | Level_l_Forecast | Forecast entered by sales manager |
| forecast | | of headquarter |
| | Level_2_Forecast | Forecast entered by sales manager |
| | | of each region |
| | Level_3_Forecast | Forecast entered by sales manager |
| | | of each corporation |
| | Level_4_Forecast | Forecast entered by sales |
| | | organization in charge of clients |
| | | of each corporation |
| | Level_5_Forecast | Forecast entered by client |

A sales area means an organizational structure whose demand forecast is entered by one or more sales managers. Sales areas different from a particular sales area may mean different organizational structures at the same level. As an example, referring to FIG. 3, the sales areas may mean organizational structures at level 3. Therefore, the particular sales area may be the USA and the other sales area may be Canada. As another example, referring to FIG. 3, sales areas may mean organizational structures at level 4. In this case, the particular sales area may be Sales 1 and the other sales area may be Sales 2.

The sales areas are not limited to those described herein with reference to FIG. 3 but may mean organizational structures or regions that establish supply planning based on the demand forecast for each level decided by an enterprise and considered as being at the same level in the course of distributing supply quantities.

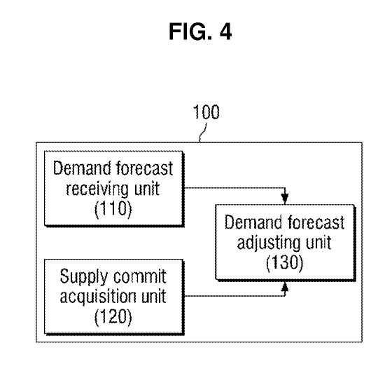

FIG. 4 is a block diagram of a demand forecast adjusting apparatus according to an embodiment of the present invention.

Referring to FIG. 4, the demand forecast adjusting apparatus 100 according to an embodiment of the present invention may include a demand forecast receiving unit 110, a supply commit acquisition unit 120 and a demand forecast adjusting unit 130.

The demand forecast receiving unit 110 receives a demand forecast for each sales area. Inputs of the demand forecast may be entered by one or more sales managers for each sales area.

The supply commit acquisition unit 120 acquires information on the supply commit for each sales area.

The information on the supply commit acquired from the supply commit acquisition unit 120 may include information on a supply commit for the sales order and information on a supply commit for a net demand forecast obtained by excluding the sales order in the demand forecast.

The demand forecast adjusting unit 130 may compare the demand forecast received by the demand forecast receiving unit 110 with the information on the supply commit and may adjust the received demand forecast.

In detail, the demand forecast adjusting unit 130 may adjust the demand forecast, specifically the committed order for the sales order and the committed forecast for the net demand forecast obtained by excluding the sales order in the demand forecast using the information on the demand forecast received by the demand forecast receiving unit 110 and the information on the supply commit.

The committed order and the committed forecast are added up, to yield the supply commit, which may be segmented into a new order that is a sales order exceeding the supply commit, a new forecast that is a net demand forecast exceeding the supply commit and not included in the new order, and an unforecasted order including the sales order exceeding the demand forecast.

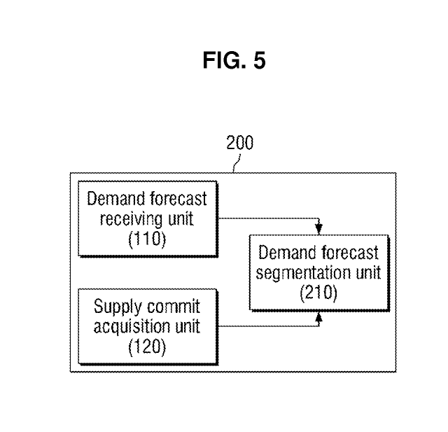

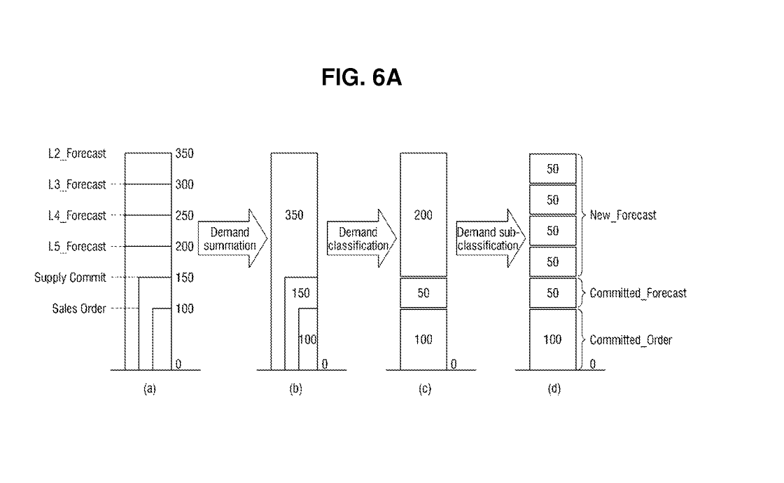

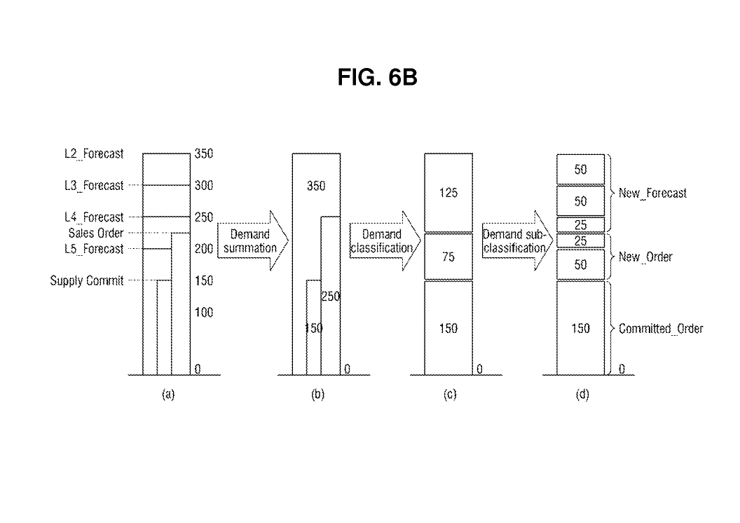

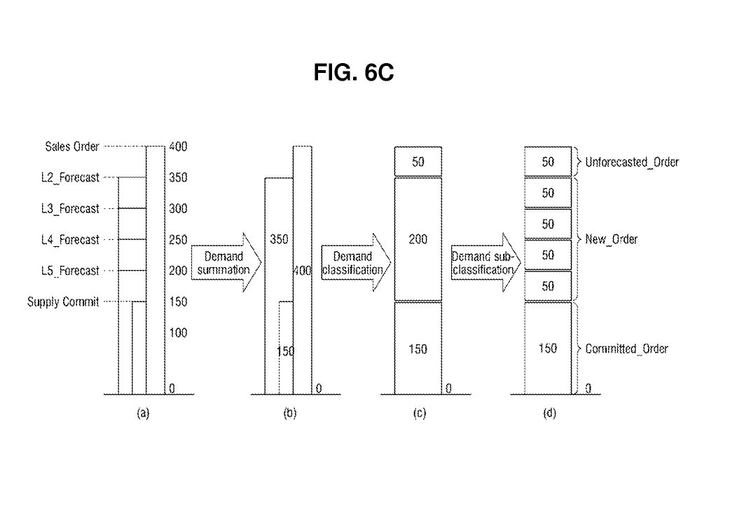

The segmentation may be performed by the demand forecast segmentation unit 210. The demand forecast segmentation unit 210, the demand forecast segmenting apparatus 200 including the same, the committed order, the committed forecast, the new order, the new forecast, and the unforecasted order will now be described in detail with reference to FIGS. 5 and 6.

FIG. 5 is a block diagram of a demand forecast segmentation apparatus (200) according to an embodiment of the present invention.

Referring to FIG. 5, the demand forecast segmentation apparatus 200 according to an embodiment of the present invention may include a demand forecast receiving unit 110, a supply commit acquisition unit 120 and a demand forecast segmentation unit 210.

The demand forecast receiving unit 110 and the supply commit acquisition unit 120 are the same as those shown in FIG. 4. The demand forecast segmentation unit 210 may segment the received demand forecast information into a demand forecast corresponding to the information on the supply commit and a demand forecast not corresponding to the information on the supply commit, for each sales area, using the information on the demand forecast received by the demand forecast receiving unit 110 and the information on the supply commit acquired by the supply commit acquisition unit 120.

In detail, the demand forecast corresponding to the information on the supply commit segmented by the demand forecast segmentation unit 210 may be classified into a committed order for the sales order from the supply commit and a committed forecast for the net demand forecast obtained by subtracting the sales order from the supply commit. In addition, the demand forecast not corresponding to the information on the supply commit segmented by the demand forecast segmentation unit 210 may be classified into a new order that is a sales order exceeding the supply commit, a new forecast that is a net demand forecast exceeding the supply commit and not included in the new order, and an unforecasted order including the sales order exceeding the demand forecast, and the demand forecast adjusting unit reduces the received demand forecast by excluding the unforecasted order, the new forecast and the new order from the received demand forecast.

The committed order, the committed forecast, the new order, the new forecast, and the unforecasted order, which may be classified by the demand forecast segmentation unit 210, will now be described in more detail with reference to FIGS. 6A to 6C.

FIGS. 6A to 6C illustrate a segmentation example of demand forecast information segmented by a demand forecast segmentation unit of the demand forecast segmentation apparatus shown in FIG. 5.

Referring to FIG. 6A, a representation (a) shows demand forecasts entered by many sales managers of a particular sales area (L2_Forecast to L5_Forecast). In the representation (a) of FIG. 6A, ‘Supply Commit’ may mean a quantity committed to supply based on the information acquired by the supply commit acquisition unit 120, and ‘Sales Order’ may mean a sales order quantity.

Referring to FIG. 6A, a representation (b) shows a total of the demand forecasts. In the representation (b), the total of the demand forecasts is 350.

Referring to FIG. 6A, a representation (c) shows demands segmented by the demand forecast segmentation unit 210. In the representation (c), a demand forecast ranging from 0 to 100 is Committed_Order, to which top priority is necessarily guaranteed, and a demand forecast of 50 ranging from 100 to 150 is Committed_Forecast, to which second priority is necessarily guaranteed.

Referring to FIG. 6A, a representation (d) shows demands segmented by the demand forecast segmentation unit 210. In the representation (d), a demand forecast ranging from 150 to 350 is New_Forecast, to which fourth priority is necessarily guaranteed.

Referring to FIG. 6B, a representation (a) shows a ‘Supply Commit’ of 150, which is the same with that shown in FIG. 6A, and a ‘Sales Order’ of 225, which is different from that shown in FIG. 6A. In this case, the demand forecast segmentation unit 210 may segment the demand forecast using the information on the supply commit. That is to say, the demand forecast segmentation unit 210 may segment the demand forecast into a Committed_Order ranging from 0 to 150, and a New_Order ranging from 150 to 225 exceeding the supply commit. In addition, the demand forecast segmentation unit 210 may segment the demand forecast exceeding the supply commit and not included in the new order into a New_Forecast ranging from 225 to 350.

Another example of demand forecast segmentation by the demand forecast segmentation unit 210 will now be described with reference to FIG. 6C.

Referring to FIG. 6C, a representation (a) shows a total demand forecast of 350 and a Supply Commit of 150, like in FIGS. 6A and 6B.

However, unlike FIGS. 6A and 6B, FIG. 6C shows that a Sales Order is 400. Therefore, the demand forecast segmentation unit 210 may segment the demand forecast into a Committed_Order ranging from 0 to 150 in the sales order but not included in the Supply Commit, and a New_Order ranging from 150 to 350 in the sales order and included in the demand forecast received by the demand forecast receiving unit 110. In addition, the demand forecast segmentation unit 210 may segment the demand forecast into an Unforecasted_Order ranging from 350 to 400 and exceeding the demand forecast.

The demand forecast information segmented by the demand forecast segmentation unit 210 may be used in adjusting the demand forecast by means of the demand forecast adjusting unit 130.

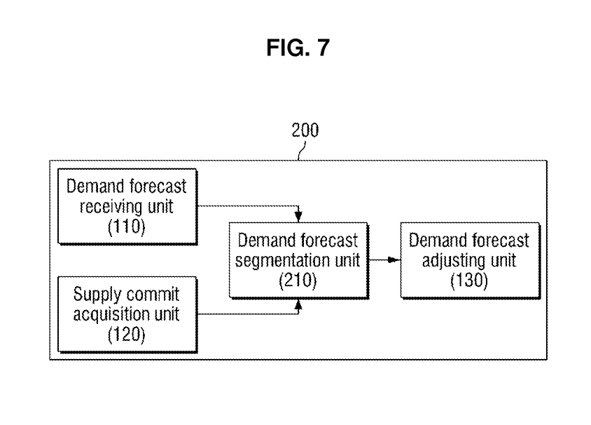

That is to say, referring to FIG. 7, the demand forecast adjusting apparatus 200 according to an embodiment of the present invention may include a demand forecast receiving unit 110, a supply commit acquisition unit 120 and a demand forecast adjusting unit 130 and may further include a demand forecast segmentation unit 210.

The demand forecast adjusting unit 130 will further be described with reference to FIGS. 4 and 7. The demand forecast adjusting unit 130 may adjust demand forecasts received from the respective sales areas based on priority in such a manner that such that top priority (first priority) is put on the Committed Order, second priority is put on the Committed Forecast, third priority is put on the New Order, fourth priority is put on the New Forecast, and fifth priority is put on the Unforecasted Order.

That is to say, the demand forecast adjusting unit 130 may adjust the demand forecasts such that the demands with high priority, among demands included in the demand forecast, can be preferentially supplied while the demands with low priority are first excluded in an event of a surplus supply or a short supply. The adjusting of the demand forecast by means of the demand forecast adjusting unit 130 may be performed such that demands comprising the demand forecasts received from the respective sale areas are classified according to priority and fulfillment of the demands with top priority and second priority are maximally guaranteed.

The demand forecast adjusting unit 130 may adjust the demand forecasts such that the product quantity corresponding to the committed order is allowed to be included in the demand forecast adjusted to guarantee supplying of products unless an unpredictably special situation happens.

In addition, the demand forecast adjusting unit 130 may adjust the demand forecasts such that the product quantity corresponding to the committed forecast is allowed to be included in the demand forecast adjusted to guarantee supplying of products except for a special case in which the demand forecast entered by the sales manager is greater than the committed order but is smaller than the committed forecast due to a change in the sales situation.

An example embodiment of the demand forecast adjusting method performed by the demand forecast adjusting unit 130 will be described in more detail with regard to different sales areas of the same level, including a first sales area, a second sales area and a third sales area.

In the first case, the demand forecast received from the first sales area among the sales areas is smaller than the supply commit of the first sales area, and the demand forecast received from the second sales area is greater than the supply commit of the second sales area.

In the first case, the demand forecast adjusting unit 130 may adjust the demand forecast of the second sales area using all or some of a quantity (a first surplus quantity) obtained by subtracting the supply commit of the first sales area from the demand forecast of the first sales area.

In detail, in the first case, the demand forecast adjusting unit 130 may adjust the demand forecast of the second sales area when the quantity (the first surplus quantity) obtained by subtracting the supply commit of the first sales area from the received demand forecast of the first sales area is smaller than a quantity (a second short quantity) obtained by subtracting the supply commit of the second sales area from the received demand forecast of the second sales area.

For example, assuming that the supply commit of the first sales area is 600 and the received demand forecast of the first sales area is 400, the first surplus quantity is 200. Assuming that the supply commit of the second sales area is 200 and the received demand forecast of the second sales area is 500, the second short quantity is 300. That is to say, in the first case, the first surplus quantity is smaller than the second short quantity. Here, the demand forecast adjusting unit 130 may adjust the demand forecast by adjusting the first surplus quantity 200 to replenish supplies of the second short quantity 300.

Finally, the demand forecast adjusting unit 130 may adjust the received demand forecast of the second sales area from the supply commit 200 to 400 replenished from the first surplus quantity 200 while maintaining the received demand forecast 400 of the first sales area as it is.

The demand forecast received from each sales area includes a committed order for the sales order. Therefore, it is necessary to guarantee supplying of at least the quantity corresponding to top priority. In addition, when the received demand forecast of a particular sales area is greater than the supply commit of the particular sales area and when there are surplus quantities in other sales areas, the demand forecast may be adjusted to replenish supplies. However, when the received demand forecast of the particular sales area is greater than the supply commit of the particular sales area but when there is no surplus quantity in other sales areas, only the supply commit is adjusted to be included in the demand forecast, so that an additional quantity of products may not be supplied.

A division in charge of supplies of products in an enterprise may finally determine a supply quantity based on the adjusted demand forecast. The demand forecast adjusting apparatus 100 according to an embodiment of the present invention may further include a transmitting unit transmitting information on the adjusted demand forecast to a supply chain management device or server.

When the first surplus quantity is smaller than the second short quantity and when there is a third short quantity in the third sales area, the demand forecast adjusting unit 130 may adjust the demand forecast using some of the first surplus quantity in replenishing supplies of the second short quantity and some of the remainder of the first surplus quantity in replenishing supplies of the second short quantity and some of the remainder of the first surplus quantity in replenishing supplies of the third short quantity.

That is to say, the demand forecast adjusting unit 130 may adjust the demand forecast for each sales area to replenish a short quantity from a surplus quantity using information on the short quantity and the surplus quantity of each sales area.

When the demand forecast adjusting unit 130 adjusts the demand forecast for each sales area such that the short quantity is replenished by the surplus quantity, the demand forecast may be adjusted to replenish the short quantity by the surplus quantity according to priorities of other segmented items of the demand forecast, including New Order, New Forecast, and Unforecasted Order, in addition to the segmented items, Committed Order and Committed Forecast.

Another case of adjusting the demand forecast by means of the demand forecast adjusting unit 130 will now be described. When the first surplus quantity obtained by subtracting the supply commit of the first sales area from the demand forecast of the first sales area is greater than the second short quantity obtained by subtracting the supply commit of the second sales area from the received demand forecast of the second sales area, the demand forecast adjusting unit 130 may adjust the received demand forecast of the second sales area to a quantity obtained by adding up as much as the second short quantity from the first surplus quantity to the supply commit of the second sales area.

When the first surplus quantity of the first sales area remains even after replenishing the short quantity of another sales area, the demand forecast adjusting unit 130 may allow the surplus quantity to be included in the demand forecast of the first sales area or to be distributed to other sales areas in a predetermined distribution ratio.

When the received demand forecast of the first sales area is equal to the supply commit of the first sales area and the received demand forecast of the second sales area is greater than the supply commit of the second sales area, the demand forecast adjusting unit 130 may adjust the demand forecast so as not to change the received demand forecast of the first sales area and the received demand forecast of the second sales area.

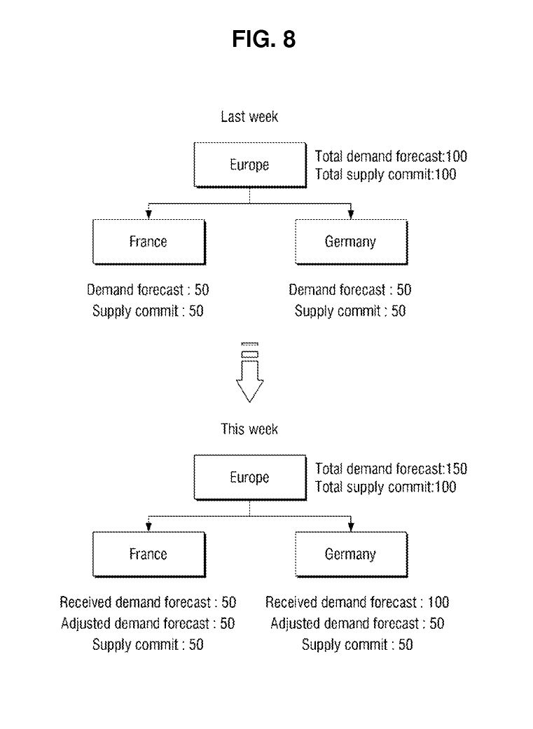

FIG. 8 illustrates demand forecasting under the same condition as in FIG. 1 when the demand forecast adjusting apparatus according to an embodiment of the present invention is employed.

When comparing the demand forecast of FIG. 8 with that of FIG. 1, this week, the demand forecast received from France is 50, which is equal to the supply commit of 50 and there is no surplus quantity, while the demand forecast from Germany is 100, the supply commit of Germany is 50 and there is no quantity to be replenished by the surplus quantity. Therefore, the adjusted demand forecast becomes 50. That is to say, France can be guaranteed in fulfilling the supply commit even due to the increase/decrease of the demand forecast in Germany.

The demand forecast adjusting apparatus 100 according to an embodiment of the present invention may be driven at an upper level supply chain management (SCM) having sales areas of one or more lower levels.

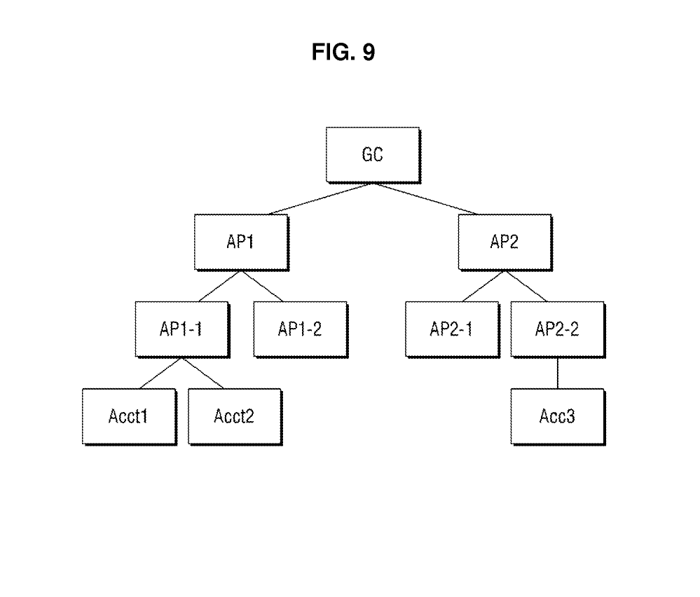

FIG. 9 illustrates layered sales areas of various levels.

Referring to FIG. 9, the demand forecast adjusting apparatus 100 according to an embodiment of the present invention may be driven in such a manner that it is incorporated into a supply chain management or server of each of a plurality of sales areas, including Ap1-1, AP1, AP2-2, AP2 and GC sales area.

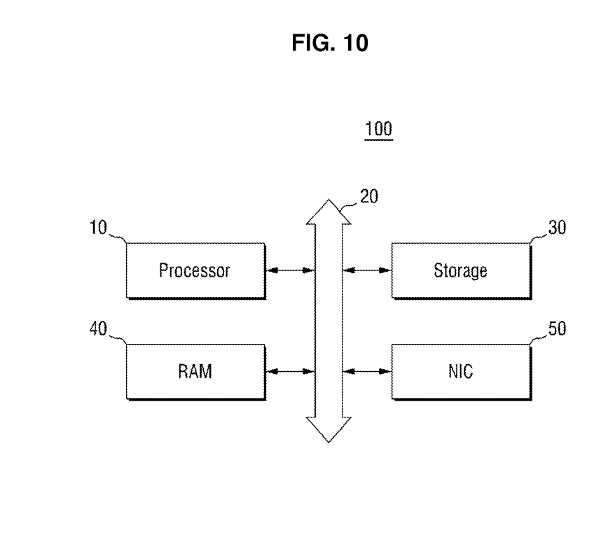

FIG. 10 is a schematic diagram of a demand forecast adjusting apparatus according to an embodiment of the present invention.

The demand forecast adjusting apparatus 100 according to an embodiment of the present invention may have such a configuration as shown in FIG. 10. The demand forecast adjusting apparatus 100 according to an embodiment of the present invention may include a hardware processor 10 executing a command, a storage 30 in which a demand forecast adjusting program data, received demand forecast data, supply commit data are stored, a memory (RAM) 40, and a network interface (NIC) 50 for data transmission/reception with respect to an external device.

The storage 30 may store a program for performing various processes of receiving the demand forecast for each sales area, acquiring information on a supply commit decided in a previous cycle for each sales area, and comparing the received demand forecast with the information on the supply commit and adjusting the demand forecast received in the receiving of the demand forecast. The program may be loaded on a memory to then be executed through the processor 10. The program stored in the storage 30 may execute at least one of the processes described with reference to FIGS. 4 to 8.

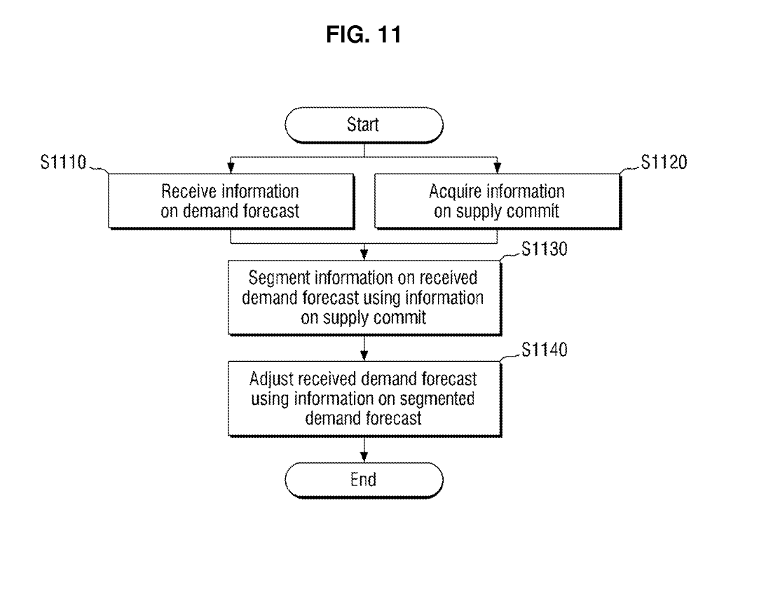

FIG. 11 is a flowchart illustrating a demand forecast adjusting method according to an embodiment of the present invention.

The demand forecast adjusting method according to an embodiment of the present invention will now be described with reference to FIG. 11.

The demand forecast receiving unit 110 may receive the demand forecast for each sales area (S1110).

The supply commit acquisition unit 120 may acquire information on the supply commit for each sales area (S1120).

The demand forecast segmentation unit 210 may segment the demand forecast into a demand forecast corresponding to the information on the supply commit and a demand forecast not corresponding to the information on the supply commit using the information on the received demand forecast for each sales area (S1130).

The demand forecast corresponding to the information on the supply commit, segmented by the demand forecast segmentation unit 210, may include a committed order and a committed forecast for a net demand forecast obtained by excluding the sales order.

In addition, the demand forecast not corresponding to the information on the supply commit, segmented by the demand forecast segmentation unit 210, may include a new order that is a sales order exceeding the supply commit, a new forecast that is a net demand forecast exceeding the supply commit and not included in the new order, and an unforecasted order including the sales order exceeding the demand forecast.

Next, the demand forecast adjusting unit 130 may adjust the received demand forecast using information on segmented demand forecast (S1140).

In detail, the demand forecast adjusting unit 130 may adjust the received demand forecast such that the demand forecast corresponding to the information on the supply commit is allowed to be included in the adjusted demand forecast.

In addition, the demand forecast adjusting unit 130 allows the committed order and the committed forecast to be included in the adjusted demand forecast, thereby guaranteeing supplying of the supply commit. In addition, when it is necessary to reduce the received demand forecast, the demand forecast adjusting unit 130 may reduce the received demand forecast by excluding Unforecasted Order, New Forecast and New Order from the received demand forecast. That is to say, when the demand forecast adjusted by the demand forecast adjusting unit 130 is smaller than the received demand forecast, the demand forecast adjusting unit 130 may first exclude the quantity of the received demand forecast corresponding to Unforecasted Order. When the quantity of the received demand forecast needs to be further excluded, the demand forecast adjusting unit 130 may additionally exclude the quantities corresponding to New Forecast and New Order.

As described above, in the demand forecast segmenting apparatus 200 and method thereof, the demand forecast adjusting apparatus 100 and method thereof and the recording medium having the program recorded therein according to the present invention, unlike in the conventional demand forecasting, demand forecast information can be more segmented using information on a supply commit, and so on.

In addition, in the demand forecast segmenting apparatus 200 and method thereof, the demand forecast adjusting apparatus 100 and method thereof and the recording medium having the program recorded therein according to the present invention, the demand forecast for each sales area can be adjusted using the segmented demand forecast information, thereby maximally maintaining the supply commit for each sales area.

That is to say, in the demand forecast segmenting apparatus 200 and method thereof, the demand forecast adjusting apparatus 100 and method thereof and the recording medium having the program recorded therein according to the present invention, the demand forecast can be adjusted so as not to unreasonably change a supply commit of a particular sales area due to a demand forecast situation of another sales area.

Further, in the demand forecast segmenting apparatus 200 and method thereof, the demand forecast adjusting apparatus 100 and method thereof and the recording medium having the program recorded therein according to the present invention, even when there is a surplus supply quantity or a short supply quantity for each sales area, the demand forecast for each sales area can be adjusted in consideration of the supply commit for each sales area, thereby achieving reasonable supply planning, compared to the conventional demand forecasting.

As used in FIGS. 4, 5 and 7, the “unit” refers to a software element or a hardware element, such as a Field Programmable Gate Array (FPGA) or an Application Specific Integrated Circuit (ASIC), which performs a predetermined function. However, the unit does not always have a meaning limited to software or hardware. The unit may be constructed either to be stored in an addressable storage medium or to execute one or more processors. The elements and functions provided by the units may be either combined into a smaller number of elements or units or divided into a larger number of elements or units.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. An apparatus for adjusting a demand forecast, the apparatus comprising:
a demand forecast receiving unit configured to receive a demand forecast;
a supply commit acquisition unit configured to acquire information on a supply commit; and
a demand forecast adjusting unit configured to compare the received demand forecast with the information on the supply commit and to provide a comparison result;
wherein:
the demand forecast adjusting unit adjusts the demand forecast received from the demand forecast receiving unit based on the comparison result; and
at least one of the demand forecast receiving unit, the supply commit acquisition unit, and the demand forecast adjusting unit is implemented with one of a hardware processor, a field programmable gate array, and an application specific integrated circuit.

2. The apparatus of claim 1, further comprising:
a demand forecast segmentation unit configured to segment the received demand forecast, using the information on the supply commit, into:
a demand forecast corresponding to information on the supply commit; and
a demand forecast not corresponding to the information on the supply commit;
wherein the demand forecast adjusting unit is further configured to adjust the received demand forecast so that the demand forecast, corresponding to the information on the supply commit, from the demand forecasts segmented by the demand forecast segmentation unit, is included in the adjusted demand forecast.

3. The apparatus of claim 2, wherein:
the demand forecast, corresponding to the information on the supply commit segmented by the demand forecast segmentation unit, includes:
a committed order for the sales order from the supply commit, and
a committed forecast for a new forecast corresponding to a net demand forecast obtained by excluding the sales order in the demand forecast, and
the demand forecast adjusting unit is further configured to adjust the committed order and the committed forecast in the adjusted demand forecast.

4. The apparatus of claim 2, wherein:
the demand forecast, not corresponding to the information on the supply commit segmented by the demand forecast segmentation unit, includes:
a new order that is a sales order exceeding the supply commit,
a new forecast that is a net demand forecast exceeding the supply commit and not included in the new order, and
an unforecasted order including the sales order exceeding the demand forecast; and
the demand forecast adjusting unit is further configured to adjust the received demand forecast by excluding, from the received demand forecast:
the unforecasted order,
the new forecast, and
the new order.

5. The apparatus of claim 1, wherein:
the demand forecast receiving unit is further configured to receive a demand forecast for each sales area of a plurality of sales areas including at least a first sales area and a second sales area, and
the supply plan acquisition unit is further configured to acquire information on the supply commit for said each sales area; and
the demand forecast adjusting unit is further configured to respond to detecting that:
the received demand forecast of the first sales area is smaller than the supply commit of the first sales area, and
the received demand forecast of the second sales area is greater than the supply commit of the second sales area,
by adjusting the demand forecast of the second sales area using at least some of a first surplus quantity obtained by subtracting the supply commit of the first sales area, from the demand forecast of the first sales area.

6. The apparatus of claim 5, wherein the demand forecast adjusting unit is further configured to adjust the received demand forecast of the second sales area to a quantity obtained by adding up all of a first surplus quantity to the supply commit of the second sales area when
the first surplus quantity is smaller than
a second short quantity obtained by subtracting the supply commit of the second sales area from the received demand forecast of the second sales area.

7. The apparatus of claim 6, wherein the demand forecast adjusting unit is further configured to respond to a detection that the received demand forecast of a third sales area among the plurality of sales areas is greater than the supply commit of the third sales area, by adjusting a demand forecast, of said each sales area, using:
at least some of the first surplus quantity in replenishing supplies of the second short quantity, and
some of a remainder of the first surplus quantity in replenishing supplies of a third short quantity obtained by subtracting the supply commit of the third sales area from the received demand forecast of the third sales area.

8. The apparatus of claim 1, wherein:
the demand forecast receiving unit is further configured to receive a demand forecast for said each sales area,
the supply plan acquisition unit is further configured to acquire information on the supply commit for said each sales area, and
the demand forecast adjusting unit is further configured to set the received demand forecast of the first sales area and the received demand forecast of the second sales area so as not to change when:
the received demand forecast of the first sales area is equal to the supply commit of the first sales area, and
the received demand forecast of the second sales area is greater than the supply commit of the second sales area.

9. The apparatus of claim 1, wherein:
the demand forecast receiving unit is further configured to receive a demand forecast for said each sales area, and
the demand forecast for each sales area is received by a manager of each sales level in said each sales area.

10. The apparatus of claim 1, further comprising a transmitter configured to transmit information on the demand forecast for said each sales area adjusted by the demand forecast adjusting unit to a supply chain management for supply planning using the demand forecast for said each sales area adjusted by the demand forecast adjusting unit.

11. A method for adjusting a demand forecast, the method comprising:
receiving a demand forecast;
acquiring information on a supply commit;
comparing the received demand forecast with the information on the supply commit to provide a comparison result; and
adjusting the received demand forecast in accordance with the comparison result;
wherein at least one of the receiving, the acquiring, the comparing, and the adjusting is implemented with one of a hardware processor, a field programmable gate array, and an application specific integrated circuit.

12. The method of claim 11, further comprising:
segmenting the received demand forecast into:
a demand forecast corresponding to information on the supply commit, and
a demand forecast not corresponding to the information on the supply commit;
wherein the adjusting of the demand forecast further comprises adjusting the received demand forecast so that the demand forecast, corresponding to the information on the supply commit, from pieces of information segmented in the segmenting of the demand forecast, is included in the adjusted demand forecast.

13. The method of claim 12, wherein:
the demand forecast, corresponding to the information on the supply commit segmented in the segmenting of the demand forecast, includes:
a committed order for the sales order from the supply commit, and
a committed forecast for a new forecast corresponding to a net demand forecast obtained by excluding the sales order in the demand forecast; and
the adjusting of the demand forecast further comprises including the committed order and the committed forecast in the adjusted demand forecast.

14. The method of claim 12, wherein:
the demand forecast, not corresponding to the information on the supply commit segmented by the demand forecast segmentation unit, includes:
a new order that is a sales order exceeding the supply commit,
a new forecast that is a net demand forecast exceeding the supply commit and not included in the new order, and
an unforecasted order including the sales order exceeding the demand forecast; and
the segmenting of the demand forecast comprises reducing the received demand forecast by excluding:
the unforecasted order,
the new forecast, and
the new order.

15. The method of claim 11, wherein:
the receiving of the demand forecast comprises receiving a demand forecast on a sales area basis for each sales area of a plurality of sales areas including at least a first sales area and a second sales area;
the acquiring of the supply commit comprises acquiring information on the supply commit for said each sales area;
when:
the received demand forecast of the first sales area is smaller than the supply commit of the first sales area, and
the received demand forecast of the second sales area is greater than the supply commit of the second sales area,
the adjusting of the demand forecast comprises adjusting the demand forecast of the second sales area using all or some of a first surplus quantity obtained by subtracting the supply commit of the first sales area from the demand forecast of the first sales area; and
when:
the received demand forecast of the first sales area is equal to the supply commit of the first sales area, and
the received demand forecast of the second sales area is greater than the supply commit of the second sales area,
the adjusting of the demand forecast comprises setting the received demand forecast of the first sales area and the received demand forecast of the second sales area so as not to change.

16. A demand forecast segmentation method comprising:
receiving information on a demand forecast;
acquiring information on a supply commit; and
segmenting the demand forecast, using the information on the received demand forecast and the supply commit, into:
a demand forecast corresponding to the information on the supply commit, and
a demand forecast not corresponding to the information on the supply commit;
wherein at least one of the receiving, the acquiring, and the segmenting is implemented with one of a hardware processor, a field programmable gate array, and an application specific integrated circuit.

17. The demand forecast segmentation method of claim 16, wherein the demand forecast corresponding to the information on the supply commit segmented in the segmenting of the demand forecast includes:
a committed order for the sales order, and
a committed forecast for the new forecast corresponding to the net demand forecast obtained by excluding the sales order in the demand forecast.

18. The demand forecast segmentation method of claim 16, wherein the demand forecast not corresponding to the information on the supply commit segmented in the segmenting of the demand forecast includes:
a new order that is a sales order exceeding the supply commit,
a new forecast that is a net demand forecast exceeding the supply commit and not included in the new order, and
an unforecasted order, including the sales order, exceeding the demand forecast.

19. A non-transitory computer readable recording medium including computer readable instructions enabling a hardware processor of a computer to implement operations comprising:
receiving information on a demand forecast;
acquiring information on a supply commit; and
comparing the demand forecast with the information on the supply commit to provide a comparison result; and
adjusting the received demand forecast in accordance with the comparison result.
